(19) United States
(12) Patent Application Publication
(10) Pub. No.: US 2008/0031097 A1
(43) Pub. Date: Feb. 7, 2008

(54) Method and System for Automatically Locating the Optimal Controller Parameters of Optical Drive

(76) Inventors: Leehter Yao, Taipei (TW); Po-Zhao Huang, Taipei (TW)

Correspondence Address: HDSL, 4331 STEVENS BATTLE LANE, FAIRFAX, VA, 22033, US

(21) Appl. No.: 11/462,375

(22) Filed: Aug. 4, 2006

(51) Int. Cl. G11B 7/085

(52) U.S. Cl. 369/30.03

(57) ABSTRACT

A method for automatically locating a set of optimal controller parameters for an optical drive includes the steps of generating a plurality sets of numerical values each having a number of the numerical values equal to a number of the controller parameters in the set of optimal controller parameters, driving the optical drive to search a plurality of tracks based on each of the plurality of numerical value sets so as to obtain a search result, if the search result meets a predetermined result, an optimal numerical value set among the plurality sets of numerical value is taken as the optimal controller parameters, and if the search result does not meet the predetermined result, generating a new plurality sets of numerical values as the plurality sets of numerical values and going back to the step of driving until the search result meets the predetermined result. As such, the optimal controller parameters of the optical drive can be automatically located.

### BACKGROUND OF THE INVENTION

1. Field of the Invention

The present invention relates to a method and system for locating the optimal controller parameters of an optical drive and particularly a method and system for automatically locating the optimal controller parameters of an optical drive.

2. Description of the Prior Art

In an optical drive, a track locating task is accomplished by using a long and short distance servo systems. Specifically, when the optical drive receives an instruction for searching a specific track of an optical disk used in the optical drive from an electronic device such as a computer, the Q-code (where the information associated with the primary format of the optical disk) is first read to determine the number and direction of the target track required to be jumped to. When the number of the target track is greater than several hundred, the coase track seeking system is first utilized to drive a motor exclusively for track searching to perform the track jumping task. When the optical pick-up head is moved near the target track, e.g. within a distance corresponding to several hundreds of tracks, the fine track seeking system is subsequently utilized to drive a coil to move the optical pick-up head to the target track. To effectively control the motion of the optical pick-up head, a plurality of parameters are set in the long and short distance servo systems, so that the optical pick-up head can be rapidly and precisely moved to the target track.

For example, the speed profile method, generally used in the track searching servo system to control the track searching task under control of an exclusive chip in the optical drive, can not be performed as an algorithm form due to the speed and operation ability of the chip and thus the speed profile is suggested to be divided into several fragments. In the case of the DVD-ROM coase track seeking system, the speed profile is divided into 11 straight line fragments capable of simulating the original speed profile, as contrast to 8 straight line fragments for the DVD-ROM short distance track searching system.

In performing the speed profile method, the track searching velocity is differently designated in the whole track searching process depending upon the track number corresponding to the distance away from the target track in the track searching task. A controller is used to designate different straight line fragments to the different distances between the current track and the target track and the track searching velocity is designated according to the slope, intercept and the distance. In this example, the slopes and intercepts of the straight line fragments associated with the speed profile are served as the controller parameters. For a DVD-ROM, 19 straight line fragments are required for the long and fine track seeking task for each of the slopes and intercepts thereof and thus 38 parameters in total are involved.

At present, the controller parameters are trial and error set in the industry, which brings to a labor waste and a limited efficacy and thus the development of the DVD-ROM requires a prolonged time, which is contrary to the current tendency where a diverse DVD-ROM products hit the market and the product cycle becomes short and short for the requirement of the users. Therefore, there is a need to provide a method and system for quickly setting these controller parameters involved in the DVD-ROM performance. The inventors of the present application envisaged a method for locating the optimal controller parameters.

### SUMMARY OF THE INVENTION

In view of the problem encountered in the prior art that an optimal control parameter set of a digital video disk (DVD-ROM) has to be trial and error set which approves time-consuming and inconvenient, it is an object to provide a method and system for automatically locating the optimal controller parameters for the DVD-ROM, with which a labor cost therefor can be reduced.

It is still another object of the present invention to provide a method and system for automatically locating an optimal control parameter set for the DVD-ROM, with which a development session therefor can be effectively reduced.

In accordance with a method for automatically locating a set of optimal controller parameters for an optical drive comprises the steps of: (a) generating a plurality sets of numerical values each having a number of the numerical values equal to a number of the controller parameters in the set of optimal controller parameters, (b) driving the optical drive to search a plurality of tracks based on each of the plurality of numerical value sets so as to obtain a search result, (c) if the search result meets a predetermined result, an optimal numerical value set among the plurality sets of numerical value is taken as the optimal controller parameters; and (d) if the search result does not meet the predetermined result, generating a new plurality sets of numerical values as the plurality sets of numerical values and going back to the step (b) until the search result meets the predetermined result.

These features and advantages of the present invention will be fully understood and appreciated from the following detailed description of the accompanying Drawings.

### BRIEF DESCRIPTION OF THE DRAWINGS

FIG. 1 is an architecture diagram of a system for automatically locating a control parameter for an optical drive according to an embodiment of the present invention;

FIG. 2 is a flowchart illustrating a method for automatically locating a control parameter for the optical drive for use in the system shown in FIG. 1;

FIG. 3 is a block diagram of an exemplified coase track seeking system used for locating a control parameter used with the system shown in FIG. 1;

FIG. 4 is a schematic operating interface of the system shown in FIG. 1;

FIG. 5 is a relationship table showing a relationship between genes in first generation chromosomes and their respective total search time according to the present invention;

FIG. 6 is a plot showing the total search time obtained with respect to the system shown in FIG. 1;

FIG. 7 is a relationship table showing a relationship between genes in an optimal chromosome in each of the late 5 generations and their total search time; and

FIG. 8 is a comparison table showing a comparison between track search time of the optical drive and the prior art optical drive.

### DETAILED DESCRIPTION OF THE PREFERRED EMBODIMENT

Other objects, features and efficacies can be more readily known when the following description made via the preferred embodiment is read with reference to the accompanying drawings.

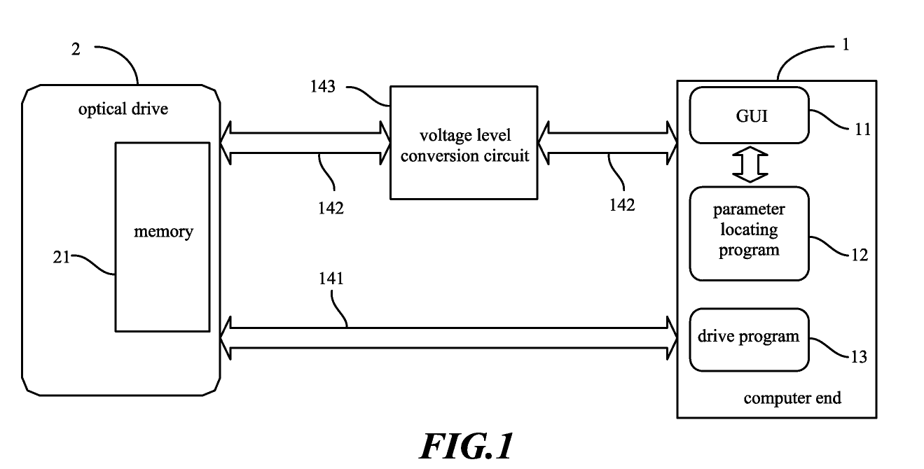

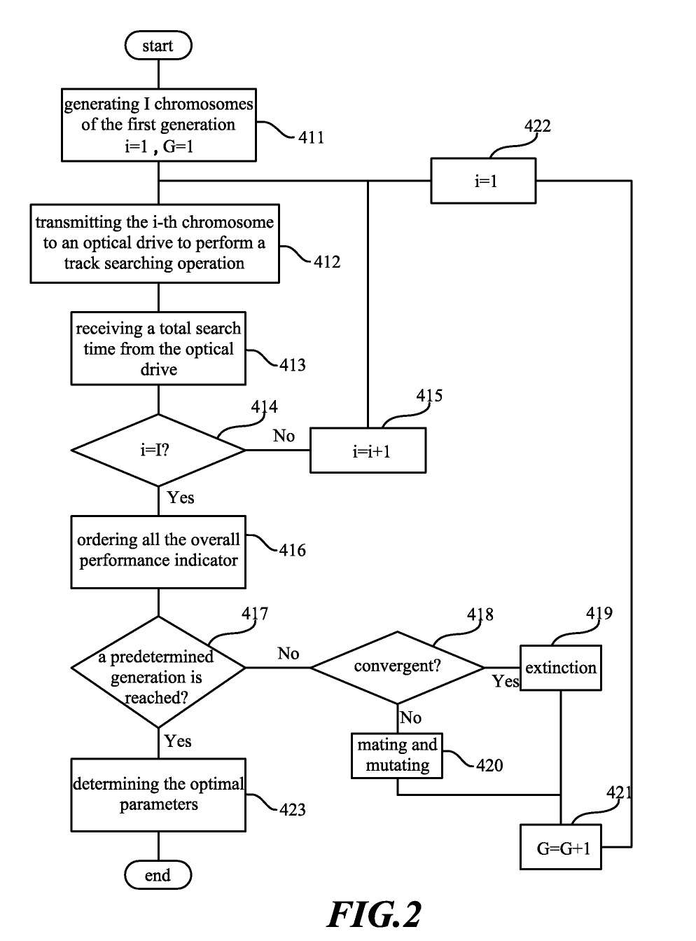

Referring to FIG. 1, an architecture diagram of a system for automatically locating the optimal controller parameters for an optical drive according to an embodiment of the present invention is depicted therein. As shown, the system is implemented on a computer 1 and coupled to the optical drive 2. Specifically, the computer 1 has a graphic user interface (GUI) program 11, a parameter locating program 12 and a drive program 13 for driving the optical drive 2 to operate and is coupled through an interface to the optical drive. The GUI program 11 is provided for a communication between the computer 1 and the optical drive 2.

In this embodiment, the parameter locating program 12 is performed based on a genetic algorithm with a plurality of search number of times of long, medium and short distances track searching, each corresponding to an absolute address, performed, in which a total search distance for the track searching is taken as a reference. By using the reference, the optimal controller parameters for the optical drive can be located based on a direction search scheme. Although the genetic algorithm is exemplified, other algorithms may also be utilized in locating the optimal controller parameters.

Specifically, each control parameter is considered as a gene (character) and all the genes are combined as a chromosome (string). The parameter locating program 12 is used to generate the genes in the chromosome randomly and I sets of such chromosome are thus generated. In the coase track seeking, it is most important to reduce the track search time as possible as the system can. In this embodiment, the optical drive 2 makes n times of track searching for long, medium and short distance tracks based on the genes in each of the chromosomes. The search time for each of the tracks being searched is summed to obtain a total search time according to Eq. 1 and an overall performance indicator is computed based on Eq. 1 as Eq. 2.

$$\begin{matrix}{T}_{\_time} = {\sum }_{i = 1}^{n} {t}_{i} & Eq . 1 \\ P = \frac{1}{{T}_{\_time}} & Eq . 2\end{matrix}$$

Wherein tᵢ is the search time for an i-th number of times of the track searching, n is a designated search number of times, T_{—}_{^{time}} is a total search time for all the track being searched and P is the overall performance indicator with respect to the track searching.

Accordingly, the parameter locating program 12 rates the chromosome according to the overall performance indicator P. Then, the parameter search program 12 executes the track searching operations in the optical drive according to the genes in the chromosomes. According to the I sets of chromosomes, I sets of search time are obtained. The I sets of chromosomes are rated according to their search time. The chromosomes rated as the best K (K<I) ones among the I chromosomes are selected to be chromosomes for a parental generation. After a mating, mutation and extinction processes, the I chromosomes for the next generation is generated. Based on the net performance index P. In this embodiment, the higher a chromosome is rated, it has a higher mating rate in the mating process conducted. The mating process is performed by a multi-points method by using Gray codes. A mutation rate for each of the genes is set as 0.01. To avoid the process for the optimal chromosomes from erroneously converging, a condition of convergence is given as the following equation:

T_{K}−T₁≦Tₛₑₜ Eq. 3

wherein T_{K} is the total search time obtained by the rated K^{th} chromosome for each generation, T₁ is the optimal total search time for each generation, and Tₛₑₜ is a designated convergence time. In this embodiment, Tₛₑₜ is set as 0.3 seconds.

If the condition of convergence is met, the extinction process is launched. The best K chromosomes is eliminated, and the rest of chromosomes are used to randomly generate the I chromosomes of the next generation. After several generations of evolution, the total search time for the long, medium and fine track seeking becomes shorter and shorter. When the total search time meets a predetermined result (termed as a stop condition), the evolution and thus the above processes stop. And the best genes in the late several generations are taken as the optimal controller parameters. In this embodiment, the predetermined number of the generation involved in the evolution process is set as 50. The best chromosomes in average in the late five generations are taken as the optimal controller parameters. Although the conditions for the mating and mutation processes and the stop condition are limited for illustration, other conditions generally used in the gene algorithm may be utilized such as the single-point mating method and homogeneous mating method. Further, the stop condition may be otherwise set as either of the overall performance indicators P of the chromosomes reaches a predetermined level without being limited by the above embodiment.

The drive program 13 is used to drive the optical drive 2 to operate normally and thus contains control programs associated with the track searching. To facilitate the reference for the optical drive 2 to be obtained, the absolute addresses involved in the n times of long, medium and fine track seeking are provided in the drive program 13 and the search time T for the track searching associated with the absolute addresses is sent to a related program in the computer 1. When the chromosomes are received by the optical drive, the n times track searching for a generation is performed and the total search time T-time is summed and sent to the computer 1.

To avoid the total search time T-time obtained from the single round of n times track searching operation from being not correct enough, this round of track searching is repeated for y (y>1) times and the y total search time T_{—}_{^{time}} is sent to the computer 1. In response to the y total search time T_{—}_{^{time}}, a medium one among them is selected by the parameter locating program 12 as the actual total search time T_{—}_{^{time}} for this single round of track searching. The reason for the non-correctness of the single round of n times track searching may be vibration and improper operation of the optical drive. Therefore, the drive program 13 is loaded to the optical drive 2 prior to the execution of the track searching method of this invention, so that the optical drive 2 can perform the track searching process and sum the total search time T_{—}_{^{time}}.

To test the track searching state with respect to the chromosome, a first transmission line 141 in compliance with the integrated drive interface (IDE) standard is provided to be electrically connected to a parallel port of the optical drive 2 and the computer 1. A second transmission line 142 in compliance with the RS-232 standard is provided to be electrically connected to a corresponding jack of the optical drive 2 and the computer 1. Since the voltage level used for the computer 1 is not equal to that for the optical drive 2, a voltage conversion circuit 143 is further provided to connect in series with the second transmission line 142, so that the voltage level between the computer 1 and the optical drive 2 can be consistent.

The optical drive 2 has a memory 21 for storing a program associated with a controller, an optical pick-up head (now shown), a track searching coil (not shown), a track searching motor (not shown), a controller chip (not shown), a parallel port, a RS-232 jack, among others. When the transmission interface is electrically connected between the computer 1 and the optical drive 2, the drive program 13 is written into the memory 21 of the optical drive 2 through the first transmission line 141 so that the track searching process can be performed. Then, the chromosomes of a specific generation are transmitted to the optical drive 2 through the second transmission line 142 and the optical drive 2 performs y rounds of n times track searching operations according thereto with respect to each of the chromosomes received by the optical drive 2. Then, the total search time T_{—}_{^{time}} with respect to each of the chromosomes is sent to the parameter locating program 12 in the computer 1.

The method for automatically locating the optimal controller parameters according to the present invention will be described below, which is performed on the above hardware system. Before the method is executed, the drive program 13 is loaded into the memory 21 of the optical drive 2 through the first transmission line 141 so that the optical drive 2 can work normally. Also assumed is that the computer 1 and the optical drive 2 have been powered up and some systems and programs associated with the track searching process have been loaded.

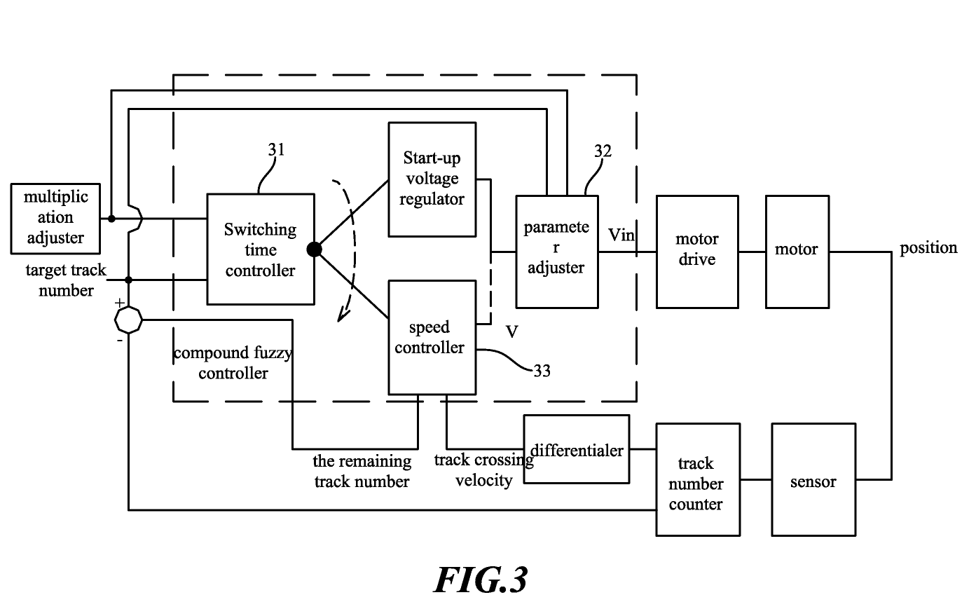

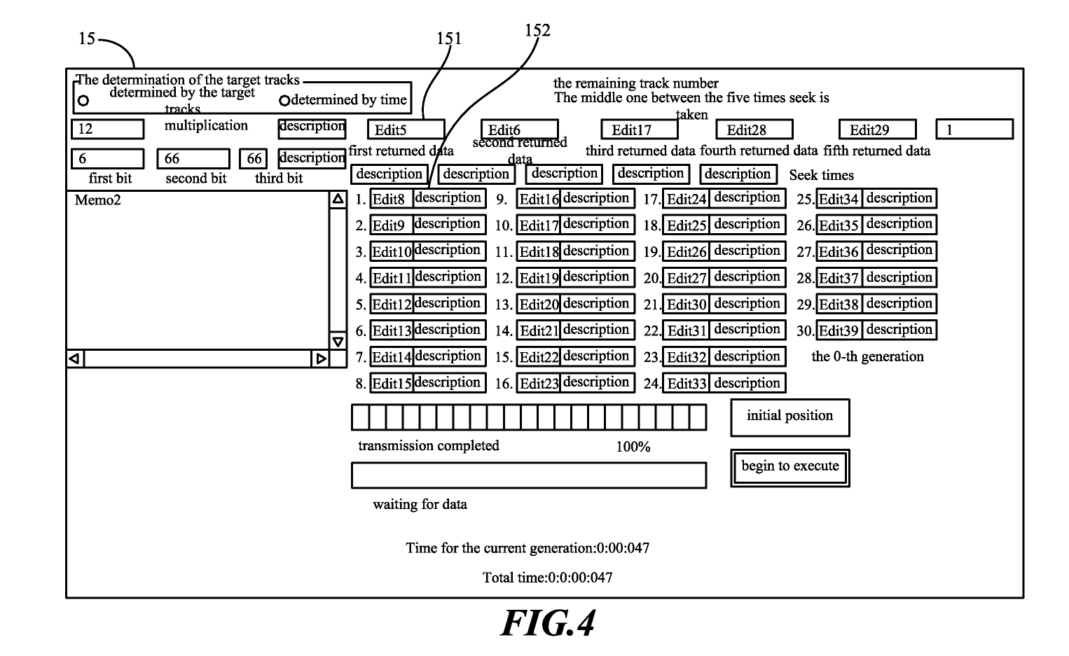

The method will be described with the control system for coase track seeking used in an optical drive, disclosed in the R.O.C. Patent No. 479,245, as an example for the illustration. FIG. 3 shows a fuzzy theory-based coase track seeking controller. The controller comprises a switching time controller 31, a parameter adjuster 32 and a speed controller 33, which are all formed based on the fuzzy theory. The switching time controller 31 judge suitable surplus tracks based on different total track crossing numbers and different track crossing speed. The surplus tracks is taken as a reference for determining whether the speed controller 33 should be used. The parameter adjuster 32 assigns a maximum voltage according to a difference between the multiplication and the total track jumping number. The searching controller 33 adjusts the Fuzzy Set of the controller parameters based on modulated span membership functions. The searching controller 33 is operated to enable the parameter 32 to provide a maximum voltage so that the motor can move to near the target track. Then, the switching time controller 31 is used to determine when the speed controller 33 should be used according to the total track jumping number and the track crossing speed.

In this exemplary control system, the optimal controller parameters comprise two controller parameters R_{wenterr} and Rᵢₚₑᵣᵣ of the speed controller 33, two controller parameters R_{c—temp} and R_{c—iperr} of the switching time controller 31 and a control parameter R_{wsktrk} of the parameter adjuster 32. Each of these controller parameters has a search range of 0 to 32767.

At first, the I chromosomes of the first generation is generated in step 411. Specifically, the parameter locating program 12 generates the I chromosomes for the first generation, each having five genes (five controller parameters) therein. In this example, the value I is set as 30 and the number of generation is set as 50. The original I chromosomes are generated randomly. In step 411, the “i” of the i-th chromosome is set as 1 and the “G” of the G-th generation is set as “1”. Thereafter, the parameter locating program 12 converses the genes in the chromosomes into the controller parameters in the form required by the optical drive 2. The controller parameters are transmitted to the optical drive 2 through a human machine interface program 11 by means of the second transmission line 142. As such, the optical drive 2 is driven to search the track therein. In this embodiment, one of such sets of chromosome is sent to the optical drive 2 at a time and the next one is sent after the total search time T-time for the y times track searching is received. In addition, the graphic user interface 15 is shown on a display (not shown) for the computer 1. As such, an engineer or operator may real time realize what has happened with the track searching process since when that happens an visual or audio message may be issued so that the engineer or operator can make a response thereto.

In addition, once the chromosome is received, the optical drive 2 begins to initialize a servo, set a primary motor speed, time for the track searching process and perform the n time track searching process for y rounds. Then, the total search time T-time of the y rounds is sent to the computer 1 and shut off the servo. In this embodiment, 649 times of track searching operations are performed (n=649) in a single round of track searching with respect to the single set of chromosomes and 5 rounds of track searching (y=5) is performed for the single set of chromosomes.

In step 413, the total track search time T_{—}_{^{time}} for the five times track searching operations contained in the single round is received by the computer 1 through the second transmission line 142 and the human machine interface program 11, which is subsequently displayed in a time field 151. Then, these total track search time T_{—}_{^{time}} is ordered according to the time values thereof and the middle one, e.g. the third total track search time T_{—}_{^{time}}, is assigned as the actual total search time T_{—}_{^{time}} and displayed in a first chromosome field 152.

Next, the parameter locating program 12 determines whether the received total search time T_{—}_{^{time}} is corresponded to the i-th chromosome, e.g. the thirty chromosome in this embodiment, in step 414. If no in step 414, the process goes to step 415. The parameter locating program 12 sets i=i+1 and the process goes back to the step 412. Then, steps 412 to 415 are repeated to obtain the total search time Tₜᵢₘₑ of a next chromosome until the total search time Tₜᵢₘₑ of all the chromosomes, in the original chromosome group, i.e. 30 chromosomes in this embodiment, are obtained.

If yes in the step 414, it means that all the I sets of chromosomes have finished their track searching operations and the process will go to a step 416. In this embodiment, the chromosomes in the same generation are sent to the optical drive 2 one by one, i.e. a next chromosome is only sent to the optical drive after the total search time of the current chromosome is obtained. In fact, the chromosomes in the same generation may also be sent together to the optical drive 2 and thus the total search time of all the chromosomes in the same generation is sent back to the computer 1 together.

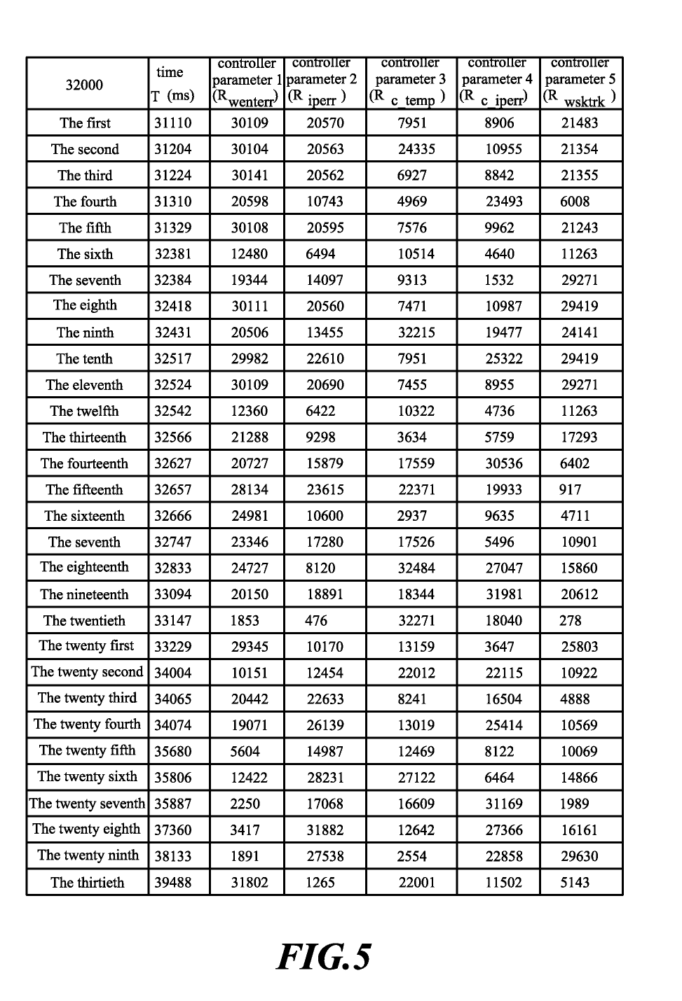

In the step 416, the parameter locating program 12 rates the chromosomes of the same generation as the overall performance indicator and orders the chromosomes according to the overall performance indicator, i.e. the total search time T_{—}_{^{time}}, which is shown in FIG. 5.

Next, whether the current generation for the chromosomes has reached the predetermined generation, i.e. the fifty generation (G=50) in this embodiment, in step 417. If no in the step 417, the process goes to step 418, where the best K chromosomes as rated in step 417 are selected to be served as seeds for evolution of a next generation. Otherwise, the current generation is determined as the predetermined generation and the process goes to a step 423, where the genes have the best ratings in average in the late several generations (e.g. 5 generations) are selected, which will be explained in the following context. In this embodiment, K is set as 10.

In step 418, whether the best K chromosomes as rated (the best 10 in this embodiment) are convergent is determined according to Equation 3. Namely, whether a difference between the total search time T_{—}_{^{time}} of the best chromosome and the tenth best chromosome is less than 0.3 seconds. If yes in the step 418, it means that the convergence result is likely to fall into a valley and thus the chromosomes are erroneously converged. At this time, the process goes to a step 419. In the step 419, an extinction process is launched where the best K chromosomes are removed so that a next generation of the I chromosomes, e.g. I=1, can be randomly generated. Then, the process goes to a step 421.

If no in the step 418, the process goes to a step 420, where the best K chromosomes are selected to generate the I chromosomes of the next generation through the mating and mutation processes. When the step 420 is finished, the process goes to a step 421.

In step 421, the generation G with the best K chromosomes rated is replaced with a next generation G (G=G+1) and the process goes to a step 422. Thus, the steps 312 to 415 are repeated until the total search time T_{—}_{^{time}} of all the chromosomes in this generation is obtained. In this manner, the evolution process continuously goes to next generations until the predetermined generation is reached.

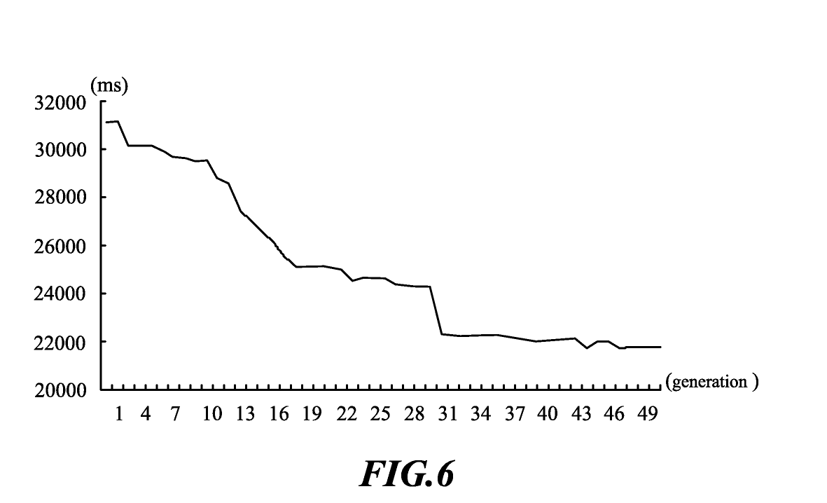

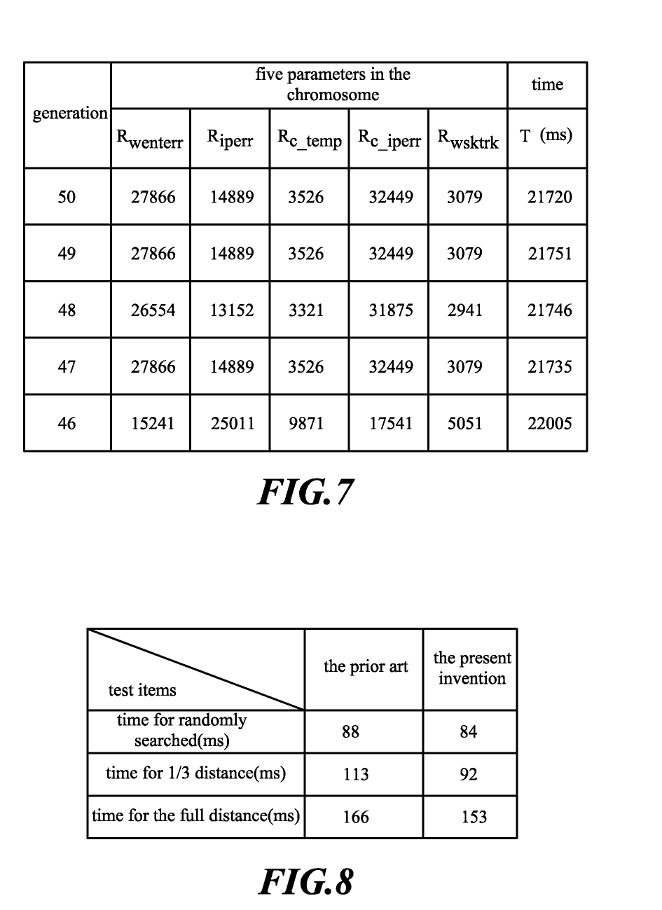

The steps 412 to 422 are repeated toward the predetermined generation as shown in FIG. 6. In the process, the optimal total search time T_{—}_{^{time}} decreases gradually and the optimal total search time of the late several generations becomes closer and closer. When the predetermined generation is reached, the genes rated as the best several ones in average are selected to be used. For example, the parameter in the best chromosome in each of the late 5 generations is taken as the optimal controller parameters, which is illustrated in FIG. 7. At this time, the controller parameters R_{wenterr} and Rᵢₚₑᵣᵣ of the speed controller 33 are 27866 and 14889, respectively, the controller parameters R_{c—temp} and R_{c—iperr} of the switching time controller 31 are 3526 and 32449, respectively, and the control parameter R_{wsktrk} of the parameter adjuster is 3079. By means of these optimal controller parameters, a firmware program for the optical drive can be edited. To avoid the execution of the program associated with the optimal control parameter locating process from having too long a time and thus causing the track searching operation erroneous, a parameter regulation table for fuzzy control for a fuzzy controller for coase track seeking is automatically generated based on the optimal controller parameters obtained as the above by the human machine interface program 11. With the parameter regulation table for fuzzy control, the fuzzy algorithm for the coase track seeking may be replaced with a parameter lookup method for fuzzy control. The thus edited firmware for the optical drive (the drive program 13 for the optical drive) is loaded to the optical drive. As such, the design for the track searching control of the optical drive is completed.

When the system for locating the optimal controller parameters for an optical drive of the invention is implemented in the currently available optical drive by using the widely used test software DVD-ROM Speed99 for the full stroke seek, ⅓ stroke seek and random seek operations, it may be demonstrated that the time required for the track searching operation is effectively shortened and thus the performance of the optical drive can be promoted.

In conclusion, the system for locating the optimal controller parameters for an optical drive of the invention locates the optimal controller parameters by enabling the human machine interface program 11 and the parameter locating program 12 in the computer to perform a real track searching operation. The parameter locating program 12 conducts the real track searching operation based on the gene rule and with a reference used therein for the evolution of the chromosomes so as to effectively find the optimal controller parameters and form an efficient track searching controller, in which the total search time of each of the chromosomes obtained in the long, medium and fine track seeking operations is taken as the reference.

Many changes and modifications in the above described embodiment of the invention can, of course, be carried out without departing from the scope thereof. For example, although the system for locating the optimal controller parameters is described based on the fuzzy theory-based coase track seeking controller, the controller parameters of the speed curve track searching control and the fine track seeking control may also be contemplated in this invention. Accordingly, to promote the progress in science and the useful arts, the invention is disclosed and is intended to be limited only by the scope of the appended claims.

What is claimed is:

1. A method for automatically locating a set of optimal controller parameters for an optical drive, comprising the steps of:
(a) generating a plurality sets of numerical values each having a number of the numerical values equal to a number of controller parameters in the set of optimal controller parameters;
(b) driving the optical drive to search a plurality of tracks based on each of the plurality of numerical value sets so as to obtain a search result;
(c) if the search result meets a predetermined result, an optimal numerical value set among the plurality sets of numerical value is taken as the optimal controller parameters; and
(d) if the search result does not meet the predetermined result, generating a new plurality sets of numerical values as the plurality sets of numerical values and going back to the step (b) until the search result meets the predetermined result.

2. The method as claimed in claim 1, wherein the plurality sets of numerical values are generated randomly.

3. The method as claimed in claim 1, wherein the step (b) further comprises generating a respective total search time for each of the plurality sets of numerical values.

4. The method as claimed in claim 3, wherein the new set of numerical values is generated based on a gene algorithm.

5. The method as claimed in claim 4, wherein the respective total search times are ordered from a minimum value to a maximum value and the new set of numerical values is generated based on a fore portion of the plurality sets of numerical values.

6. The method as claimed in claim 5, wherein if fore portion of the plurality sets of numerical values converges, the new plurality sets of numerical value are generated randomly again.

7. The method as claimed in claim 5, wherein if fore portion of the plurality sets of numerical values does not converge, the new plurality of numerical value sets are generated by mating and mutating the fore portion of the plurality sets of numerical value.

8. The method as claimed in claim 4, wherein the predetermined result is a predetermined generation.

9. The method as claimed in claim 8, wherein a respective optimal set of numerical values for a late portion of all generations is taken as the optimal control parameter set.

10. The method as claimed in claim 3, wherein the respective total search time is a search time by summing a plurality of search times each for searching an address of a corresponding one of the plurality of tracks.

11. The method as claimed in claim 10, wherein the step (b) further comprises obtaining the plurality of total search times corresponding to the plurality sets of numerical values, ordering the respective total search times from a minimum value to a maximum value, and using a middle one of the plurality of total search time as the search result.

12. A system for automatically locating optimal controller parameters for an optical drive implemented on a computer, comprising:
a graphical user interface (GUI) program configured for communicating with the optical drive;
a parameter locating program used for generating a plurality sets of numerical values each corresponding to one of the optimal controller parameters; and
a transmission interface electrically connected to the optical drive and the computer, wherein the plurality sets of numerical values are sent to the optical drive through the GUI program and the transmission interface and the optical drive is driven to search a plurality of tracks based on the plurality sets of numerical values, the parameter locating program determines whether a search result meets a predetermined result and when the search result is determined as meeting the predetermined result an optimal set of numerical values is taken as the optimal controller parameters, and when the search result does not meet the predetermined result, a new plurality sets of numerical values are generated in place of the plurality sets of numerical values until the search result meets the predetermined result.

13. The system as claimed in claim 12, further comprising a drive program for driving the optical drive and the transmission interface having a first transmission line in compliance with an integrated drive interface standard through which the drive program for driving the optical drive is sent to the optical drive.

14. The system as claimed in claim 13, wherein the transmission interface has a second transmission line in compliance with a RS-232 standard through which the plurality sets of numerical values are sent to the optical drive and the search result is sent to the computer from the optical drive.

15. The system as claimed in claim 14, wherein the transmission interface further has a voltage conversion circuit connected in series with the second transmission line, so that the voltage levels of the computer and the optical drive are consistent with each other.

16. The system as claimed in claim 12, wherein the parameter locating program is performed based on a genetic algorithm and the system further comprises a drive program for obtaining a respective total search time for each of the plurality sets of numerical values to be taken as a reference for the parameter locating program.

17. The system as claimed in claim 16, wherein the parameter locating program further has an operating interface for displaying the locating result.

18. A method for automatically locating optimal controller parameters for an optical drive, comprising the steps of:
(a) generating I (I is a positive integer) number of chromosomes of a generation each containing a number of genes equal to that of the optimal controller parameters;
(b) driving the optical drive to search a plurality of tracks according to the I number of chromosomes and calculating a respective total search time of each of the I number of chromosomes;
(c) ordering the respective total search times of the I number of chromosomes from a minimum value to a maximum value;
(d) if the I number of chromosomes in the step (c) meets a stop condition, a fore portion of the I number of chromosomes is served as the optimal controller parameters; and
(e) if the I number of chromosomes does not meet the stop condition, using a fore K (K is a positive integer and K<I) number of chromosomes among the I number of chromosomes to generate a next generation of chromosomes and going back to the step (b).

19. The method as claimed in claim 18, wherein a first one of the generations is generated randomly.

20. The method as claimed in claim 18, wherein the step (b) further comprises generating a respective total search time with respect to a plurality of tracks each having a specific address for each of the plurality sets of numerical values for each of the I number of chromosomes, wherein the respective total search time is a sum of a search time of each of the plurality of tracks for the respective I number of chromosomes.

21. The method as claimed in claim 20, wherein the step (b) further comprises driving the optical drive to perform a plurality of rounds of the searching the plurality of tracks each having the specific address for each of the I number of chromosomes so as to obtain a plurality of total search times each associated with a corresponding one of the plurality of rounds, ordering the total search times of the plurality of rounds from a minimum value to a maximum value, and using a middle one of the total search times of the plurality of rounds as the total search time of the I number of chromosomes.

22. The method as claimed in claim 18, wherein the stop condition is a predetermined generation.

23. The method as claimed in claim 18, wherein when the fore K number of the chromosomes converges, the step (e) further comprising a step of regenerating a next generation of the I number of chromosomes randomly.

24. The method as claimed in claim 5, wherein when the fore K number of the chromosomes does not converge, the step (e) further comprising a step of generating the next generation of the I number of chromosomes by mating and mutating the fore K number of the chromosomes.

25. The method as claimed in claims 23, wherein the fore K number of chromosomes converges when a difference between the total search times of the K-th chromosome and the first chromosomes is not greater than a convergence time.

26. The method as claimed in claim 22, wherein in the step (d) a first chromosome in each of a late portion of all the generations is taken as the optimal controller parameters.

27. The method as claimed in claims 24, wherein the fore K number of chromosomes converges when a difference between the total search times of the K-th chromosome and the first chromosomes is not greater than a convergence time.
